(19) United States
(12) Patent Application Publication
(10) Pub. No.: US 2011/0214425 A1
(43) Pub. Date: Sep. 8, 2011

(54) ENERGY-EFFICIENT SYSTEM FOR GENERATING CARBON BLACK, PREFERABLY IN ENERGETIC COOPERATION WITH SYSTEMS FOR GENERATING SILICON DIOXIDE AND/OR SILICON

(75) Inventors: Jürgen Erwin Lang, Karlsruhe (DE); Hartwig Rauleder, Rheinfelden (DE); Bodo Frings, Schloss Holte (DE); Mustafa Siray, Bonn (DE); Rudolf Schmitz, Bornheim (DE); Dietmar Wewers, Bottrop (DE); Peter Nagler, Frankfurt (DE); Rainer Wendt, Moerfelden-Walldorf (DE); Georg Markowz, Alzenau (DE)

(73) Assignee: EVONIK DEGUSSA GMBH, Essen (DE)

(21) Appl. No.: 13/128,442

(22) PCT Filed: Nov. 5, 2009
(86) PCT No.: PCT/EP2009/064717

§ 371 Date: May 10, 2011

Related U.S. Application Data
(60) Provisional application No. 61/112,891, filed on Nov. 10, 2008.

(30) Foreign Application Priority Data
Nov. 10, 2008 (DE) 10 2008 043 606.2

(51) Int. Cl. F01K 27/00; C01B 33/12; C01B 31/02

(52) U.S. Cl. 60/643; 423/335; 423/449.1

(57) ABSTRACT

The object of the invention is a more energy-efficient system for utilizing waste heat and residual gases from the engineered generation of carbon compounds, such as carbon black, graphite or from sugar pyrolysis, using a coupling of energy-heat or a thermal heat-generating plant for generating electrical energy, in particular for operating melt furnaces, and/or for utilizing the waste heat in endothermal processes. The invention also relates to the use of waste heat.

The invention provides a more energy-efficient plant for utilizing waste heat and residual gases from the industrial production of carbon compounds, such as carbon black, graphite, or from sugar pyrolysis, by means of a combined heat and power system or of a thermal power plant for production of electrical energy, especially for the operation of melting furnaces, and/or for utilization of the waste heat in endothermic processes, and the corresponding use of the waste heat.

The inventive plant can achieve a considerable process intensification in the production of silicon, which leads to a significant reduction in climatically harmful carbon dioxide and/or carbon monoxide, and to a significantly reduced demand for electrical energy. Furthermore, recycling of silicon oxide which is formed in the reduction of silicon dioxide to silicon in a light arc oven can significantly enhance the mass balance of the silicon used in the overall process.

To date, the waste heat, i.e. the thermal energy, obtained in the production of carbon black has not been made utilizable in a technical and economically viable manner for other processes. The waste heat of the carbon black processes is currently typically utilized for preheating of the reactants, such as air for combustion and oil, in the same process. Accordingly, the waste heat of the production of silicon, especially in the form of hot process gases, has also to date merely been quenched with air and passed through hot gas filters to remove silicon dioxide. The tail gas obtained in these processes is converted to power. Utilization of the considerable amounts of thermal energy from carbon black or silicon production to save energy in other processes has not been possible to date. Especially in the case of production of the high-purity carbon blacks or of silicon which is suitable for production of solar silicon or else for production of semiconductor silicon, the conversion of the excess thermal energy was inconceivable owing to the need for spatial separation of particular operations for production of high-purity products. The exceptionally high demands on the particular purity of the products and the possibility of cross-contamination categorically ruled out this possibility.

A known process for producing carbon blacks is the gas black process (DRP 29261, DEC 2931907, DEC 671739, Carbon Black, Prof. Donnet, 1993 by MARCEL DEKKER, INC, New York, page 57 ff.), in which a hydrogen-containing carrier gas laden with oil vapors is combusted in an excess of air at numerous exit orifices. The flames impact against water-cooled rollers, which stops the combustion reaction. Some of the soot formed within the flame is precipitated on the rollers and is scraped off them. The soot remaining in the offgas stream is removed in filters. Additionally known is the channel black process (Carbon Black, Prof. Donnet, 1993 by MARCEL DEKKER, INC, New York, page 57 ff.), in which a multitude of natural gas-fed small flames burn against water-cooled iron channels. The soot deposited on the iron channels is scraped off and collected in a funnel.

The processes mentioned give rise to a large amount of waste heat, especially in the form of hot residual gases with temperatures less than 200° C., including hot steam. In the furnace black process, tail gas is formed as the residual gas.

To date, the waste heat has been partly removed from the gases, for example by means of condensers, and the gases are then cleaned and blown into the environment. The waste heat removed has to date not been utilized extensively.

Owing to the fine particulate structure of the carbon blacks, contamination of other plant parts with carbon black cannot be ruled out. For this reason, plants of this type have not been combined at one production site with other plants which have likewise been utilized for production of high-purity compounds.

On the other hand, for example, the drying step in the production of silicon oxide, especially of silicon dioxide, such as precipitated silica or silica which has been purified by means of ion exchangers, requires supply of a particularly large amount of energy in order to dry the moist silicon oxides.

It was an object of the present invention to develop an energy-efficient plant, and to provide an efficient use of the thermal energy in the production of carbon black, and especially of silicon dioxide. It was a further object to develop an overall plant which enables the thermal energy to be utilized with a high efficiency for an overall process and the overall use in the production of silicon.

The objects are achieved by the inventive plant, especially as an overall plant or else a plant component, and the inventive use corresponding to the features of the independent claims; the subclaims and the description disclose preferred embodiments.

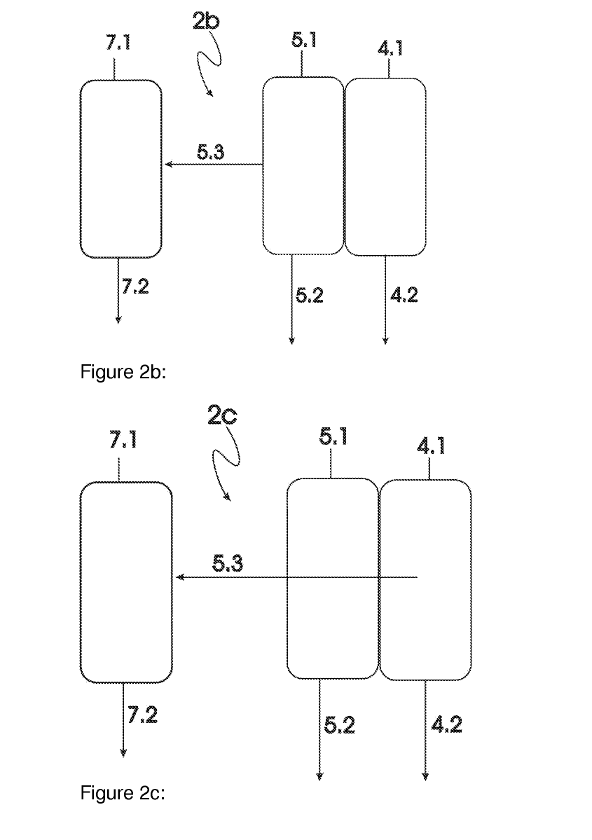

The invention provides an overall plant 2 with a reactor 4.1 for thermal conversion of carbon-containing compounds, said reactor being connected to a combined heat and power system 5.1, by means of which a portion of the waste heat 5.3 from the thermal conversion is withdrawn and another portion of the waste heat is converted to electrical energy 5.2, the withdrawn waste heat 5.3 being utilized in the process for producing silicon oxide, especially in a process step in the production of silicon dioxide, in the apparatus 7.1. Particular preference is given to utilizing the waste heat indirectly or directly for heating or temperature regulation of the precipitation vessel for formation of precipitated silicas or silica gels and/or for drying silicon oxide, especially silicon dioxide, such as precipitated silica or silica gels, which has been purified by means of ion exchangers, in the apparatus 7.1; the waste heat 5.3 is especially conducted by means of heat exchangers 8, preferably in a secondary cycle. In a preferred alternative, direct drying of SiO₂ with superheated steam 5.3 can be effected, as shown in FIG. 2b or 2c. It is possible to use low-temperature steam 5.3 to operate contact dryers, as described below.

The electrical energy obtained from the combined heat and power system 5.2 can be utilized for energy supply of a reactor 6.1 for reduction of metallic compounds, for production of silicon dioxide, more preferably in the production of precipitated silica, fumed silica or silica gels, and/or utilized with preference for drying and/or for temperature regulation during the precipitation, in apparatus 7.1. Equally possible is the utilization of the electrical energy for the operation of an apparatus in the production of pyrogenic oxides, for example fumed silica. In one possible variant, the electrical energy can be utilized in the desorption to recover HCl in these processes. The overall plant allows silicon oxide and carbon black production to be provided at one site and, if appropriate, the reactor 6.1 for reduction of metallic compounds to be provided at another site via a power network.

For the combined heat and power system, it is possible to use apparatus 5.1 or plants 5.1 which are sufficiently well known to those skilled in the art. The combined heat and power system has a significantly better efficiency than pure power generation of thermal power plants. The overall efficiency of combined heat and power systems in particularly preferred cases may be up to 90%. According to the invention, the combined heat and power system may be operated not just with power and heat, but also exclusively with power or heat. A combined heat and power system works generally with hot steam, which drives steam turbines, by means of which the power is then generated. The withdrawal of steam and supply to a heat exchanger, preferably to a process for production of silicon dioxide, for example for temperature regulation or for drying of silicon oxide, in an apparatus 7.1, is generally effected upstream of the last turbine stage. In the inventive plant, the withdrawal can appropriately also be effected downstream of the last turbine stage. Typically, for example, the temperature of a precipitation vessel is regulated or the silicon oxide, such as precipitated silica or a silica gel, is dried by means of heat exchangers, i.e. by means of a secondary cycle. Equally possible is direct utilization of the waste heat for drying, as described above. The combined heat and power system can draw the waste heat from carbon black production, such as preferably downstream of the quench zone or other hot reactor parts, for example via heat exchangers or direct utilization of the process vapors and/or from the combustion of the tail gases, which may serve in turn to produce steam. Preference is given to operating the combined heat and power system with steam. The tail gases comprise, among other substances, steam, hydrogen, nitrogen, Cx, carbon monoxide, argon, hydrogen sulfide, methane, ethane, ethene, ethyne, amides, nitrogen-containing compounds, metal oxides such as aluminum oxides and/or carbon dioxide. The combined heat and power system preferably works in back-pressure operation, as a result of which no thermal losses occur in the steam cycle processes. As a result, there is generally no demand for fresh cooling water.

According to the invention, a carrier gas downstream of the preheating zone of the combustion air and/or the waste heat from the combustion of the tail gases in 5.1 can be utilized as the waste heat 5.3. More preferably, superheated steam 5.3 from 4.1 or via 5.1 can also be utilized directly in a process for production of silicon dioxide, as shown in FIGS. 2b and 2c, especially for direct drying of silicon dioxide, such as silica gel or precipitated silica. Additionally or alternatively, it is possible to use low-temperature steam to operate a contact dryer (apparatus 7.1), for example plate dryer or preferably a rotary tube dryer. The stream obtained from 5.1 can preferably also be used to operate primary dryers, especially spray tower dryers or spin flash dryers, for drying silicon dioxide.

According to the invention, it is possible to provide the carbon black production and the production of silicon oxide, especially of the precipitated silica or of the silica gel, at one production site or else in a combined plant, because possible cross-contamination of carbon black and silicon oxide for production of silicon, especially of solar silicon in the reactor 6.1, is unimportant for this overall process. This combination had been inconceivable to date, since contamination of carbon black with silicon dioxide or silicon dioxide with carbon black was to be avoided. In the underlying processes here, those for producing silicon from silicon oxide, especially silicon dioxide, and carbon black and/or pyrolyzed carbohydrates, the silicon oxide is reduced in the reactor 6.1 to silicon, such that the cross-contamination of high-purity carbon black, high-purity pyrolyzed carbohydrates or high-purity silicon dioxide is not troublesome for this specific application.

Likewise preferably, the waste heat from the individual plant parts or else from the combustion of tail gas from carbon black production is utilized by means of heat exchangers 8 via a secondary cycle, in order to prevent contamination of the high-purity carbon blacks, carbon-containing compounds or of the high-purity silicon oxide, especially silicon dioxide, with other impurities, such as other metals.

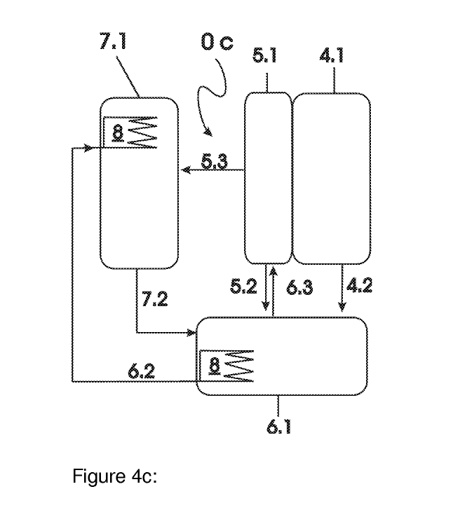

The invention further provides an overall plant, such as 0a or 0b, in which a reactor 4.1 for thermal conversion of carbon-containing compounds is connected to a combined heat and power system 5.1, by means of which a portion of the waste heat 5.3 from the thermal conversion in 4.1 can be withdrawn and another portion of the waste heat can be converted to electrical energy 5.2, the withdrawn waste heat 5.3 being utilized in an apparatus 7.1, especially in processes for production of silicon dioxide. The apparatus 7.1 may be part of a plant for production of silicon dioxide. The waste heat 5.3 or the waste heat stream 5.3 can preferably be utilized in the apparatus 7.1 for temperature regulation of a precipitation vessel and/or for drying of silicon oxide, especially of silicon dioxide, such as precipitated silica, silica gel or silica which has been purified by means of ion exchangers. The waste heat withdrawn is especially utilized directly (see FIG. 2b/2c) or by means of heat exchangers 8, as in FIGS. 4a and 4b, and the electrical energy 5.2 for energy supply of a reactor 6.1 for reduction of metallic compounds or in processes for production of silicon dioxide, especially for the apparatus 7.1, and, if appropriate, the waste heat 6.2 from the reactor 6.1 can additionally be utilized for reduction of metallic compounds in a process for production of silicon dioxide, for example for temperature regulation or for drying of silicon oxide, in the apparatus 7.1. In alternatives, the combined heat and power system may also be purely power- or heat-operated.

For further optimization of the energy balance, it is preferred when the waste heat 6.2 of the reactor for reduction of metallic compounds in the apparatus 7.1 is utilized; more particularly, the waste heat 6.2 is transferred by means of heat exchangers 8 from the reactor 6.1 into the apparatus 7.1. This can be done by virtue of the waste heat, especially a waste heat stream 6.2, of the reactor 6.1 being connected to the apparatus 7.1.

Preferably, in addition, the hot process gases from the reactor 6.1 for reduction of metallic compounds are introduced via a hot gas line 6.3 into the reactor 4.1 for thermal conversion of carbon. A hot gas line 6.3 preferably connects the reactor 6.1 for reduction of metallic compounds and the reactor 4.1 for thermal conversion of carbon, especially for transfer of the hot process gases from the reactor 6.1 into the reactor 4.1.

Additionally or alternatively, the hot process gases from the reactor 6.1 for reduction of metallic compounds can be passed via a hot gas line 6.3 into the combined heat and power system 5.1 or into the thermal power plant 5.1. A hot gas line 6.3 preferably connects the reactor 6.1 for reduction of metallic compounds with the combined heat and power system 5.1 or a thermal power plant 5.1, especially for transfer of the hot process gases from the reactor 6.1 into 5.1 for steam raising. This design of the plant is shown by way of example in the plant 0c in FIG. 4c for all conceivable overall plants or plant components.

According to the invention, the hot gas line 6.3 of plants 0a, 0b or 1c is designed such that it very substantially prevents condensation of the gaseous silicon oxide of the hot process gases which form in the production of silicon. The hot process gases typically comprise carbon monoxide, silicon oxide and/or carbon dioxide. The condensation of the silicon oxide harbors a considerable risk of detonation. The hot gas line is therefore provided on its inner surface with “blanketing”, which reduces, preferably prevents, this condensation on the inner surface of the hot gas line. Alternatively to the blanketing, the hot gas line may be equipped with trace heating and/or have an air gas feed for temperature regulation over the surface, especially for reactive temperature increase, preferably in the wall region. The recycling of the hot process gases from the reduction step to molten silicon in 6.1 into the reactor 4.1 can enhance the yield of silicon by up to 20 mol % because the gaseous silicon oxide formed remains in the process. By virtue of the inventive plant, the overall process can thus even lead to an increase in yield of silicon in relation to the silicon oxide used. Owing to the exothermicity introduced in the hot gases, the amount of natural gas in carbon black production is simultaneously also reduced.

The blanketing can be accomplished, for example, via the generation of vortices. One further component of the hot process gases transferred into the reactor 4.1 is carbon monoxide. In the underlying process, the introduction of silicon oxide into the reactor for production of carbon black or for pyrolysis of carbohydrates is not disruptive when the reaction products are utilized for production of silicon. In addition, the introduction of carbon monoxide in the hot process gases via the hot gas line into the reactor 4.1 enables a favorable shift there in the equilibrium of the hot gas in the combustion or thermal cleavage of the carbon black raw materials or of the carbohydrate-containing compounds. The process regime enabled in the inventive plant is accompanied by a significant reduction in the level of carbon oxides, especially of carbon dioxide, in the overall process for production of silicon.

Stream 7.2 represents, in schematic terms, the stream which, directly or indirectly, transfers a product from the apparatus 7.1, for example a precipitation vessel or reactor for drying of silicon dioxide, into reactor 6.1. The direct product from 7.1 can also be sent to a further processing step, such as drying, grinding, granulation, tableting, conversion or blending with carbon black, carbohydrates or carbohydrate-containing compounds, or other processing or process steps, before the indirect product is fed to reactor 6.1.

In one alternative, the invention provides an inventive plant—plant component—1a with a reactor 4.1 for thermal conversion of carbon-containing compounds, the reactor being connected to a combined heat and power system 5.1, by means of which a portion of the waste heat 5.3 from the thermal conversion is withdrawn and/or another portion of the waste heat is converted to mechanical or electrical energy 5.2, or said reactor 4.1 being connected to a thermal power plant 5.1, by means of which the waste heat is converted to mechanical or electrical energy 5.2. The electrical energy generated can be fed into the public grid system, or be used internally for power supply or, in accordance with the invention, to operate the light arc furnaces in silicon production or for production of silicon oxide, preferably of precipitated silica or fumed silica or silica gels, and in the case of precipitated silicas and silica gels more preferably for drying or heating of the precipitation vessel.

In one possible variant, the electrical energy can be utilized in the process for producing fumed silica, for example in the desorption for HCl recovery in these processes. The withdrawn waste heat can be fed into a district heating grid, preference being given to utilizing the waste heat for further use in the production of silicon, via heat exchangers, in the process for production of silicon dioxide, such as for temperature regulation or for drying silicon oxide, especially of silicon dioxide.

The reactors for thermal conversion of carbon-containing compounds include all reactors for production of carbon black, graphite, carbon or generally of a compound containing a carbon matrix, for example including silicon carbide-containing carbons, and also further corresponding compounds familiar to those skilled in the art. According to the invention, the reactor 4.1 for thermal conversion of carbon-containing compounds is a reactor or furnace for production of carbon black or for combustion and/or pyrolysis of carbohydrates, for example the pyrolysis of sugar, optionally in the presence of silicon dioxide, for production of carbon-containing matrices, for example in the presence of high-purity silicon oxide. Typical reactors for production of carbon back are operated at process temperatures of 1200 to more than 2200° C. in the combustion chamber. The best known processes for production of carbon black are the lamp black process, the furnace black process, the gas black process and the lamp black, acetylene black or thermal black processes. Accordingly, the reactor 4.1 is preferably designed for performance of the processes mentioned. For the inventive plant, preference is given to using a reactor known from the prior art for production of carbon black or for thermal conversion of carbon-containing compounds. Such reactors are sufficiently well known to those skilled in the art.

Typical reactor types generally comprise all furnaces suitable for carbon black production. These may in turn be equipped with various burner technologies. One example thereof is the Hüls light arc furnace (light furnace). For the selection of the burner, it is crucial whether a high temperature in the flame or a rich flame is to be obtained. The reactors may comprise the following burner units: gas burners with an integrated combustion air blower, gas burners for swirled air streams, combination gas burners with gas injection via peripheral lances, high-velocity burners, Schoppe impulse burners, parallel diffusion burners, combined oil-gas burners, pusher furnace burners, oil evaporation burners, burners with air or vapor atomization, flat flame burners, gas-fired jacketed jet pipes, and all burners and reactors which are suitable for production of carbon black or for pyrolysis of carbohydrates, for example of sugar, optionally in the presence of silicon dioxide. The reactor 4.1 is interpreted as being the entire reactor or else parts of the reactor; for example, the reactor comprises the reaction chamber, a combustion zone, a mixing zone, reaction zone and/or quench zone. According to the invention, recuperators are utilized in the quench zone, for example jet recuperators with a ring of steel tubes.

A further alternative embodiment envisages a combination in which the inventive plant 1b or 1b.1—as a plant component—comprises a reactor 4.1 for thermal conversion of carbon-containing compounds, said reactor being connectable to a combined heat and power system 5.1, by means of which a portion of the waste heat 5.3 from the thermal conversion can be withdrawn and/or another portion of the waste heat can be converted to mechanical or electrical energy 5.2, or said reactor 4.1 being connected to a thermal power plant 5.1, by means of which the waste heat is converted to mechanical or electrical energy 5.2 and the electrical energy 5.2 is utilized for energy supply of a reactor 6.1 for reduction of metallic compounds, especially a light arc furnace 6.1, electrical melting furnace, thermal reactor, induction furnace, melting reactor or furnace, preferably for production of silicon, or else for energy supply of an apparatus 7.1 in the production of silicon dioxide, for example for temperature control of a precipitation vessel, for drying of silicon oxide, such as SiO₂, or else for the operation of an apparatus in the process for producing fumed silica.

The person skilled in the art is aware that 5.1 can also be operated in such a way that exclusively the waste heat 5.3 or electrical energy 5.2 or any mixed forms are utilized. In this case, the withdrawn waste heat 5.3 is conducted to the apparatus 7.1, and the waste heat 5.3 is especially transferred by means of a heat exchanger 8 or utilized directly as superheated steam (FIGS. 2b and 2c); the apparatus 7.1 is preferably part of a plant for producing silicon oxide.

In all variants of the inventive plants, the carbon black produced, the pyrolyzed carbohydrate, can be fed via 4.2 indirectly or directly to the light arc furnace 6.1. “Indirectly” means that the compounds produced in the reactor 4.1 can still be processed further before they are fed to reactor 6.1. By way of example, but not exclusively, the carbon black or the carbon-containing compound can be pelletized or briquetted.

It is particularly preferred in accordance with the invention when the plant has a feed line 6.3 of the hot process gases from the reactor 6.1 for reduction of metallic compounds via a hot gas line 6.3 into the reactor 4.1 for thermal conversion of carbon, as shown by way of example for plants 1c and 0b. In a preferred configuration, the plant, especially the overall plant 0a, allows the utilization of the waste heat 6.2 of the reactor 6.1 for reduction of metallic compounds in processes for producing silicon dioxide, for example for thermal control of precipitation vessels or in the drying of silicon dioxide in the apparatus 7.1; the waste heat 6.2 is more particularly transferred via heat exchangers 8 from the reactor 6.1 into the apparatus 7.1.

The apparatus 7.1 may, in all plants, be a precipitation vessel for precipitation or gel formation of SiO₂, or else a dryer, a tunnel furnace, rotary tube furnace, rotary grid furnace, fluidized bed, rotary table furnace, circulating fluidized bed apparatus, continuous furnace and/or a furnace for pyrolysis. For instance, it is possible with preference to directly use superheated steam 5.3, which is obtained indirectly or directly in 4.1, for example by quenching with water, from the waste heat of 4.1 or via the combustion of the tail gases from 4.1, for drying of silicon dioxide (FIGS. 2b and 2c).

With low-temperature steam 5.3, one option is the operation of contact dryers 7.1, for example of plate dryers or more preferably of rotary tube dryers. The stream 5.2 obtained via 5.1 can be used directly to operate primary dryers. These are preferably spray tower dryers or spin flash dryers. It is clear to those skilled in the art that the above list should be understood only by way of example and it is also possible to use other customary dryers.

For the reactors 4.1 or 6.1, all of the waste heat which arises there, or else portions thereof, for example from the reaction zone, the hot reactor parts, steam resulting from quenching with water in 4.1 or else the waste heat of the reaction products, such as gases or other streams, shall be considered in accordance with the invention as utilized waste heat. According to the invention, the residual gas (tail gas) in particular is combusted, and the waste heat formed is utilized in the inventive plant.

The plant preferably works continuously, 24 hours, 7 days per week, such that the waste heat is also utilized, directly or via the heat exchangers 8, in a continuous circulation process, especially via primary and/or secondary cycles. The energy saving thus achievable, per kilogram of dried silicon dioxide, may be between 0.01 and 10 kWh, preferably 2 to 6 kWh, more preferably around 2 kWh. It is clear to those skilled in the art that the energy balance achieved in the particular case depends directly on the residual moisture content and the dryer apparatus utilized, and also further process parameters, such that the values mentioned should only be understood as guide values. In the case of utilization of the electrical energy obtained, of about 0.01 to 10 kWh, preferably between 0.1 and 5 kWh, per kilogram of carbon black for reduction of each kilogram of silicon dioxide to molten silicon, there is a savings potential of 1 to 10 kWh, especially of 4 to 9 kWh, including the process for production of silicon dioxide. For production of about one kilogram of molten silicon, the energy saving may increase to 5 kWh to 20 kWh; more particularly, considering the overall process comprising the production of silicon dioxide and carbon black and the conversion thereof to silicon, it may be in the region of 17 kWh.

In a further preferred embodiment, the waste heat 6.2 can be utilized together with the waste heat 5.3 in a process for production of silicon dioxide for the apparatus 7.1, preferably for heat treatment or for drying of silicon dioxide, especially of precipitated silica or silica gel, or precipitated silica or silica gel which has been purified by means of ion exchangers. Preference is given to utilizing the waste heat 6.2 and/or 5.3 for drying the silica via one or more heat exchangers 8. The apparatus 7.1 may, in all plants, be a component of a plant for production of silicon dioxide.

Heat exchangers 8 are preferably used in order to prevent contamination of the silicon dioxide, especially of high-purity silicon dioxide. In these heat exchangers, by means of a secondary cycle, the waste heat from the reactor 6.1 is utilized in a process for production of silicon dioxide, such as for drying of silicon dioxide or temperature control of a precipitation vessel. Typically, in the heat exchangers and/or in the inlets and outlets of the waste heat, the medium utilized is water, a customary cooling fluid or other media sufficiently well known to those skilled in the art.

An appropriate plant 3 also envisages the sole utilization of the waste heat 6.2 from the reactor 6.1 for reduction of metallic compounds 5.3 in processes for production of silicon dioxide in the apparatus 7.1, more particularly for temperature control of a precipitation vessel 7.1 or dryer 7.1 for drying silicon dioxide; the plant 3 is more particularly connectable to the plant 1a; the waste heat 6.2 is preferably passed out of the reactor 6.1 into the apparatus 7.1 by means of heat exchangers 8.

It is obvious that the apparatus 7.1, which may especially be a reactor, precipitation vessel and/or dryer, is only one part of a plant component or overall plant for production of silicon oxide and is connected or connectable upstream and/or downstream to further plants or apparatus, in order to produce, for example, high-purity silicon dioxide from contaminated silicates.

More particularly, the feed line 7.2 in all plants is also considered to be a direct or indirect feed line into the reactor or as a stream into the reactor 6.1. For instance, the silicon dioxide dried in 7.1 can also be subjected to further processing steps before it is supplied to the reactor 6.1. These are especially grinding, formulating, briquetting. In these steps too, it is possible to use the electrical energy flow according to 5.2.

According to the invention, the waste heat of the reactor 4.1 is used for thermal conversion of carbon-containing compounds to produce electrical energy, especially by means of a combined heat and power system or of a thermal power plant. Waste heat is also considered to be the waste heat of the tail gases, and the waste heat which arises through combustion of the tail gas. It is particularly preferred when the waste heat is utilized entirely or partly, especially directly or indirectly, in processes for production of silicon dioxide, such as for temperature control or for drying. Preferably, superheated steam from 4.1 and/or 5.1 can be utilized in 7.1 for drying or temperature control (FIGS. 2b/2c).

This combined use of the waste heat in accordance with the invention has to date been inconceivable to the person skilled in the art, because the possible cross-contamination would have led to considerable problems in the process regime. Only the combined use of silicon dioxides purified in or from aqueous systems, and carbon black or pyrolyzed carbohydrates, for production of high-purity silicon makes this combined synergistic utilization of the waste heat or of the thermal energy possible.

The electrical energy obtained can preferably be used to operate a reactor 6.1 for reduction of metallic compounds or to operate apparatus 7.1, in processes for production of silicon dioxide, preferably for operation of dryers, such as primary dryers, furnaces for production of fumed silica for production of silicon, or for temperature control of precipitation vessels or for the operation of other process steps which work with electrical power. As stated at the outset, the energy balance of the overall process comprising carbon black production, the production of silicon oxide and/or the reduction of the silicon dioxide is improved considerably over known plants and the known use from the prior art.

For instance, the energy balance of the silicon dioxide process can preferably be improved considerably in the particularly energy-intensive steps, for example the heating of the precipitation vessel or in drying steps of the silicon dioxide, and also further process steps to which energy has to be supplied. The combined process regime, the systematic utilization of waste heat, combustible residual gases, and/or the recycling of the hot gas from 6.1 allow all circuits in the plant to be operated with an improved energy balance over known prior art processes. For instance, the recycling of the hot gases, which include carbon monoxide and silicon oxide, especially gaseous SiO, into the reactor 4.1 leads to process intensification; more particularly, the formation of carbon oxides COx during the process for production of carbon black can be reduced in the overall balance. The overall process in the inventive overall plant or else in the component plants leads to a considerable reduction in the carbon dioxide and/or carbon monoxide formed over the overall process in the production of silicon, especially from compounds comprising silicon dioxide and carbon, such as carbon black or pyrolyzed sugar.

According to the invention, the hot process gases from the reactor 6.1 are additionally used for reduction of metallic compounds in the reactor 4.1 to thermally convert carbon in the reactor 4.1, especially by virtue of them being introduced via a hot gas line 6.3 from the reactor 6.1 into the reactor 4.1.

Likewise in accordance with the invention, the hot process gases from the reactor 6.1 can be utilized for reduction of metallic compounds in the combined heat and power system 5.1 or in the thermal power plant 5.1 to raise steam and/or to generate energy, more particularly by virtue of them being introduced into 5.1 via a hot gas line 6.3 from the reactor 6.1.

According to a further aspect of the invention, the waste heat of a reactor 6.1 can be used for reduction of metallic impurities in processes for production of silicon dioxide, especially in the apparatus 7.1, such as heat treatment vessels or dryers. In addition, the reactors 4.1 and/or 6.1 and the apparatus 7.1 are generally in turn part of a plant for the particular process lines, i.e. 7.1 is, for example, part of the silicon dioxide generation, 4.1 is part of a plant for production of carbon black or pyrolyzed carbohydrates, etc, and 6.1 may be part of a plant for production of solar silicon with upstream and/or downstream further process stages.

It is clear to those skilled in the art that the plants mentioned, instead of in each case one reactor in the particular process stage, may also have a multitude of reactors; this may especially allow continuous and/or homogeneous and disruption-free performance of the overall process. The reactors may be operated continuously or else batchwise.

Generally, the reactors 4.1 for thermal conversion of carbon, especially for production of carbon black, incorporated in the plant may preferably be reactors of analogous design, as described in the patent cited. With regard to the disclosure content, reference is made entirely to the disclosure of the reactors and the operating modes thereof mentioned in U.S. Pat. No. 5,651,945, U.S. Pat. No. 6,391,274 B1, EP 0 184 819 B1, EP 0 209 908 B1, EP 0 232 461 B1, EP 0 102 072 A2, EP 1 236 509 A1, EP 0 206 315 A1, EP 0 136 629 A2, U.S. Pat. No. 4,970,059 and U.S. Pat. No. 4,904,454.

The figures which follow illustrate the inventive plant in detail, without restricting the invention to this example.

### REFERENCE NUMBERS

0a, 0b, 0c, 1a, 1b, 1c, 2, 2a, 2b, 2c, 3: Alternative plants or plant combinations, overall plant;
4.1: reactor for thermal conversion of carbon-containing compounds, for example reactors for production of carbon black or for pyrolysis of carbohydrate, such as the pyrolysis of sugar, optionally in the presence of silicon dioxide;
5.1: combined heat and power system, thermal power plant,
6.1: reactor, for example electrical melting furnace, induction furnace, light arc furnace;
7.1: apparatus for use for production of silicon dioxide, for example in a drying stage, preferably a dryer, for example fluidized bed reactor or other reactor for drying of substrates, a reactor, an apparatus in the process for production of fumed silica, or else a precipitation vessel;
8: heat exchangers; they preferably have a secondary cycle and enable the waste heat (thermal energy) to be drawn off from processes, in 4.1 and/or 6.1, and the supply of the thermal energy to endothermic processes, especially to 7.1 for drying;
4.2: stream, for example feed line(s) which enable(s) indirect or direct feeding of the product from 4.1, which may also be subjected beforehand to further processing, such as briquetting, into the reactor 6.1;
5.2: electrical energy flow, for example line for conduction of electrical energy;
6.2: thermal energy flow, for example line(s), especially with attached heat exchangers 8, for utilization of the waste heat from 6.1 in 7.1, preferably as a secondary cycle;
7.2: stream, for example feed line(s) and optionally production stages, through which the product from 7.1 can be transferred indirectly or directly to the reactor 6.1, the direct product from 7.1 also being feedable to further processing, such as drying, grinding, granulation, tableting, reaction or blending with carbon black, carbohydrates or carbohydrate-containing compounds, or other processing or process steps, before the indirect product is fed to the reactor 6.1;
a. thermal energy flow, or energy flow such as superheated steam or low-temperature steam, which is utilized, for example, through tubes, optionally with attached heat exchangers 8, for utilization of the waste heat from 4.1, which is withdrawn via 5.1, for drying or temperature control in 7.1;
6.3: hot gas line.

The figures show:

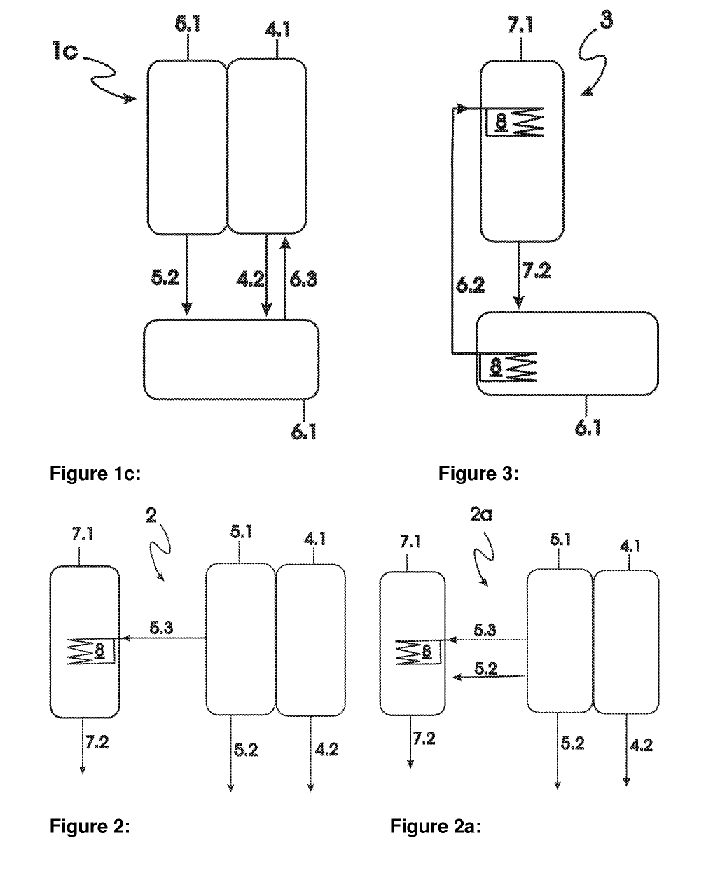

FIG. 1a, 1b, 1b.1, 1c: Alternative plant combinations or component combinations of reactors for production of carbon black together with a combined heat and power system, optionally together with reactors for production of solar silicon.

FIGS. 2, 2a, 2b and 2c show inventive combinations of plants in which a thermal treatment step or drying step in the production of silicon dioxide by means of a combined heat and power system (5.1, 5.3 or 5.2) utilizes the waste heat from carbon black production (4.1) in the form of energy. According to FIG. 2c, steam from the quench zone can be introduced through 5.1 into 7.1 as superheated steam.

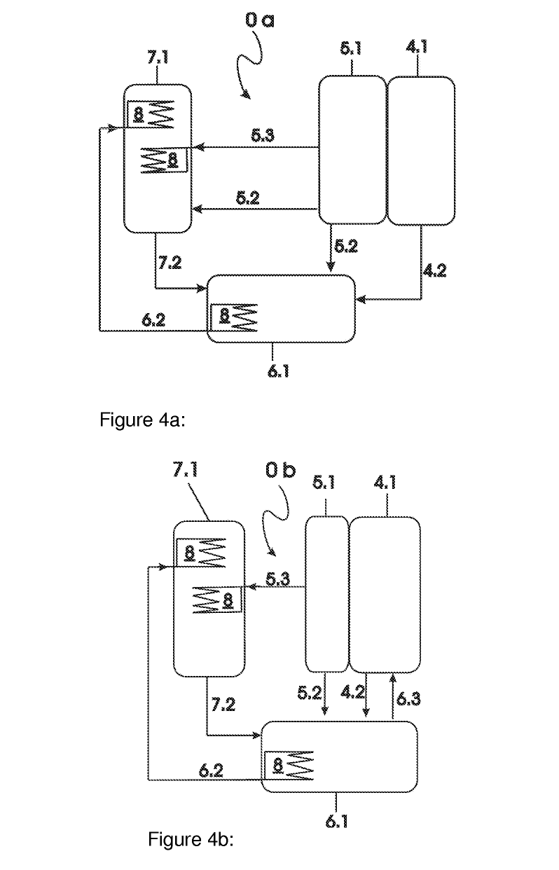

FIG. 3 shows the utilization of the waste heat from a melting furnace for production of silicon in the production of silicon dioxide.

FIGS. 4a, 4b and 4c each show possible overall plants (0a, 0b or 0c) for production of silicon with production stages from silicon dioxide production and carbon black production.

FIG. 1a shows a plant 1a with a reactor 4.1 for thermal conversion of carbon-containing compounds, said reactor being connected to a combined heat and power system 5.1, by means of which a portion of the waste heat 5.3 of the thermal conversion is withdrawn and another portion is converted to mechanical or electrical energy 5.2. The line 5.3 is used to draw off the withdrawn heat. According to the process regime, all of the waste heat or a portion of the waste heat can be utilized for temperature control of the apparatus 7.1 or for energy generation. It is possible to use the waste heat to control the temperature of a precipitation vessel or else to operate dryers 7.1. Via 5.2, the electrical energy generated can be passed on. The electrical energy can be fed into the public grid system, or be utilized in the process for production of silicon dioxide or directly in an overall process for production of silicon in an electrical furnace, for example a light arc furnace 6.1. According to the plant 1b, 5.1 can be utilized exclusively for power generation, in which case the stream can also be utilized for operation of 7.1 or other plant parts. FIG. 1c represents the combination of the plant 1a with a reactor 6.1. Plant 1c may be part of an overall plant and additionally has a hot gas line 6.3 between 4.1 and 6.1.

The plants 2 and 2a constitute inventive combinations which allow, through a combined heat and power system (5.1), the utilization of the waste heat (5.3) and of the electrical energy generated (5.2) in the process for production of silicon dioxide, which is suitable especially for production of silicon, especially of solar silicon. Alternatives are shown by the plants 2b and 2c, in which no heat exchanger is utilized in 7.1. The process is operated directly with superheated steam.

The plants—overall plants—0a, 0b and 0c likewise show inventive plants which are especially part of an overall plant for production of silicon, especially of solar silicon, in which the waste heat from the reactors 4.1 and 6.1 is utilized in an apparatus 7.1, for example precipitation vessel or dryer, in the production of silicon dioxide, for example from wet chemical processes, such as the precipitation of silica from waterglass or else the purification of waterglass by means of ion exchange columns. The heat exchangers 8 are optional. In the plant 0c, the hot gas stream 6.3 is passed back into 5.1, and in the plant 0b into 4.1. It is clear to those skilled in the art that 6.3 can also be transferred into 5.1 and 4.1.

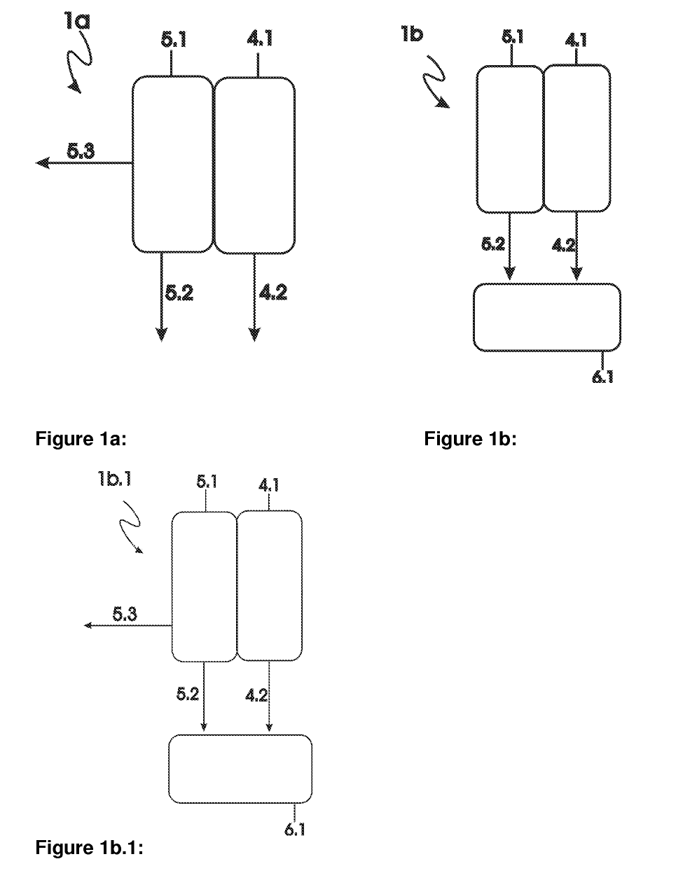

Alternative plants in accordance with the invention, as shown schematically in FIG. 0b or 0c, and the energy and streams thereof, are explained in detail hereinafter.

In these alternatives, the electrical energy 5.2 obtained in 5.1 is utilized for operation of 7.1, while the reactor 6.1 is fed by additional power. Proceeding from 4.1, the burner is fed with natural gas, in order to be able to achieve the required temperatures of up to 2000° C. To produce about one kilogram of carbon black, approximately 0.2 kilogram of natural gas has been required to date, which contributes about 2 kWh. Through the choke, a further 1.5 kg of feedstock are fed in, which contribute about 15 kWh/kg. In a further process stage, air is introduced into the carbon black reactor; especially to preheat the combustion air of the quench zone, the reactions which proceed in carbon black production are quenched with water. For each kilogram of carbon black produced, a tail gas with an energy content of about 1 to 10 kWh/kg of carbon black, preferably of about up to 5 kWh/kg of carbon black, is obtained. This tail gas can be used, through combustion in 5.1, to raise steam, which is transferred into 7.1, in order to be utilized there for drying of SiO₂, by way of example. The energy content of this steam may be about 1 to 8 kWh, preferably up to 4 kWh. In order to illustrate the energy demand of 7.1, it must be considered that between 2 and 5 kilograms of water, typically about 4 kilograms of water, have to be evaporated there per kilogram of silicon dioxide dried. The evaporated water from 7.1 can, as afterheat, be utilized for the operation of greenhouses or else discharged through the roof. A preferred alternative envisages the utilization of the steam for energy generation. The energy content of about 4 kilograms of steam at about 102° C. is in the region of about 4 kWh in addition to the utilizable heat of condensation. For all kWh reported, a wide range of variation of at least +/−50% of the value reported in kWh has to be taken into account, since the energy balances of the particular streams and energy flows influence one another. In addition, the person skilled in the art is aware that only approximate values can be determined in such a complex network of processes.

For the operation, for example, of a light arc furnace 6.1, for production of about one kilogram of silicon from about 1 kg of carbon black and 3 kg of silicon dioxide, about 14 kWh of power are required. This forms, in the charge composition under the reaction conditions at up to 2000° C., gaseous silicon oxide which, together with carbon monoxide likewise formed, as hot gases at 600 to 700° C., has to date been quenched with air, oxidized and filtered. In the inventive plant, these hot gases can alternatively or else simultaneously be introduced into 4.1, especially in the region of the burner or choke. The hot gases have, for each kilogram of silicon produced, about 0.4 kg of silicon oxide and approximately 2.3 kg of carbon monoxide, and the energy content may be up to 9 kWh per kilogram of silicon. This measure allows about 0.5 l of oil/kg of carbon black, or 1 to 6 kWh/kg, preferably up to 5 kWh/kg, of carbon black to be saved.

In addition, it is possible to recover about 0.2 kg of silicon per kilogram of silicon through the recycling. This may mean an increase in yield of 1 to 25% by weight, preferably of 5 to 20% by weight, more preferably of 15 to 22% by weight, in relation to the silicon end product proceeding from silicon used in the SiO₂ starting material.

Alternatively or additionally, the hot gas stream 6.3 can also be introduced into 5.1, for example in order to raise steam there, by means of which power can in turn be generated. Thus, in 5.1, for each kilogram of silicon produced, 1 up to 11 kWh, especially 5 to 10 kWh, preferably up to 9 kWh, of heat can be utilized to produce steam and/or power. At the same time, the silicon oxide entrained can be deposited as silicon dioxide and be added to the process in 5.1 or to the process for production of silicon dioxide. The outlined use of the streams and/or energy flows and the process regime in an inventive plant enables a considerable improvement in the energy balance of the overall process for production of silicon, and simultaneously an increase in the yield of silicon.

1. A plant comprising a reactor (4.1) for thermal conversion of carbon-containing compounds, said reactor (4.1) being connected to a combined heat and power system (5.1), by means of which a portion of waste heat (5.3) from the thermal conversion is withdrawn and another portion of the waste heat is converted to mechanical or electrical energy (5.2), or said reactor (4.1) is connected to a thermal power plant (5.1), by means of which the waste heat is converted to mechanical or electrical energy (5.2).

2. The plant according to claim 1, wherein the withdrawn waste heat (5.3) is conducted to an apparatus (7.1), and wherein the waste heat (5.3) is transferred into the apparatus (7.1) by a heat exchanger (8).

3. The plant according to claim 1, wherein the electrical energy (5.2) is utilized for energy supply of a reactor (6.1) for reduction of metallic compounds, and wherein the reactor (6.1) is configured as one of a light arc furnace (6.1) and a melting reactor or furnace.

4. The plant according to claim 3, wherein hot process gases from the reactor (6.1) for reduction of metallic compounds are introduced via a hot gas line (6.3) into the reactor (4.1) for thermal conversion of carbon, or into the combined heat and power system (5.1), or into the thermal power plant (5.1), or a combination thereof.

5. The plant according to claim 3, wherein a hot gas line (6.3) connects the reactor (6.1) for reduction of metallic compounds with one of the reactor (4.1) for thermal conversion of carbon and the combined heat and power system or the thermal power plant (5.1) for transfer of the hot process gases from the reactor (6.1) into the one of the reactor (4.1) and the combined heat and power system (5.1) or the thermal power plant (5.1).

6. The plant according to claim 2, wherein a waste heat stream (6.2) of the reactor (6.1) for reduction of metallic compounds is utilized in the apparatus (7.1), and wherein the waste heat stream (6.2) is transferred from the reactor (6.1) into the apparatus (7.1) by a heat exchanger (8).

7. The plant according to claim 6, wherein the waste heat stream (6.2) of the reactor (6.1) is connected to the apparatus (7.1).

8. The plant according to claim 6, wherein hot process gases from the reactor (6.1) for reduction of metallic compounds are introduced via a hot gas line (6.3) into the reactor (4.1) for thermal conversion of carbon, the combined heat and power system (5.1), or the thermal power plant (5.1).

9. The plant according to claim 6, wherein a hot gas line (6.3) for introduction of hot process gases from the reactor (6.1) for reduction of metallic compounds connects the reactor (6.1) to one of the reactor (4.1) for thermal conversion of carbon and the combined heat and power system (5.1) or the thermal power plant (5.1).

10. (canceled)

11. A method of producing electrical energy, comprising using waste heat of a reactor (4.1) for thermal conversion of carbon-containing compounds, by means of a combined heat and power system or of a thermal power plant.

12. The method according to claim 11, further comprising using the waste heat in the production of silicon oxide.

13. The method according to claim 11, further comprising using electrical energy (5.2) from the combined heat and power system or thermal plant for operating one of a reactor (6.1) for reduction of metallic compounds and an apparatus (7.1).

14. A method for thermal conversion of carbon-containing compounds, comprising using hot process gases (6.3) from a reactor (6.1) for reduction of metallic compounds in a reactor (4.1) to thermally convert carbon in the reactor (4.1), wherein the hot process gases are introduced via a hot gas line (6.3) from the reactor (6.1) into one of the reactor (4.1) and the combined heat and power system (5.1) or the thermal power plant (5.1) to raise steam.

15. A method of producing silicon dioxide, comprising using a waste heat stream (6.2) of a reactor (6.1) for reduction of metallic compounds in the heat treatment or drying of the silicon dioxide.

16. The plant according to claim 2, wherein the apparatus 7.1 is configured for producing silicon dioxide.

17. The plant according to claim 16, wherein the apparatus is at least one of a precipitation vessel, a reactor, and a dryer.

18. The plant according to claim 3, wherein the light arc furnace (6.1) and the melting reactor or furnace are configured to produce solar silicon.
